(19) United States
(12) Patent Application Publication
(10) Pub. No.: US 2021/0229245 A1
(43) Pub. Date: Jul. 29, 2021

(54) DEVICE ENABLING MULTIPLE FASTENER DRIVE HEADS UTILIZING A SINGLE DRIVE CONFIGURATION

(71) Applicant: Nagy Kodsy, Scarsdale, NY (US)

(72) Inventor: Nagy Kodsy, Scarsdale, NY (US)

(21) Appl. No.: 17/156,218

(22) Filed: Jan. 22, 2021

Related U.S. Application Data
(60) Provisional application No. 62/965,540, filed on Jan. 24, 2020.

(51) Int. Cl. B25B 15/00

(52) U.S. Cl. CPC B25B 15/005; B25B 15/007

(57) ABSTRACT

A tool that self-adjusts to fit different fastener-head configurations without any need for user intervention.

### FIELD OF INVENTION

The present invention relates to the proliferation of fastener head configurations used across various industries resulting from the dramatic increase in the use of permanent, and/or removable, threaded fasteners. With the growth in the use of threaded fasteners new design for fastener drive heads have been introduced. This proliferation of fastener drive head configuration has necessitated that companies and consumers must have numerous tools or detachable/attachable tool attachments to ensure they have the correct drive head design for a particular task. These tools and attachments are costly to purchase, can be lost or misplaced, and cost time with delays as the user has to find and exchange tools each time a different fastener type is encountered. The tool described herein allows a user to have a single device that is designed to automatically adjust the driver head configuration to a number of fastener drive configurations without requiring the user to take any additional action or change out for alternate chucks for each configuration.

### BACKGROUND OF THE INVENTION

As the use of permanent and removable threaded fasteners has expanded throughout industrial and consumer product manufacturing the number and variety of fastener head drive configurations has grown rapidly. Basic threaded fasteners such as wood and metal screws had generally used either flat head (slotted head) or Philips head driver configuration that provide the attachment drive purchase to attach the fastener. As the use of threaded fasteners has grown exponentially the number of driver head configuration has grown. From the two configurations (slotted Head and Philips) we now have more then a dozen driver head configurations, each requiring a unique tool or tool attachment.

Industry in general and the consumers in particular are now required to have dozens of tools and attachments to attach and/or detach these various fasteners for product assembly or repair. This proliferation of fastener drive configuration has created an unnecessary expense and frustration as numerous tools are required to accomplish what should be simple processes. This a cost of time and money can be avoided with a device that incorporates multiple configurations within a single that adjusts each configuration automatically.

### SUMMARY OF THE INVENTION

The present invention incorporates several fastener drive head configurations within a single tool such that each configuration automatically adjusts to the drive head configuration need for the immediate task.

Existing tools provide a selection of multiple drive heads either in individual special purpose tools or through the use of attachments to the single tool where the user must either stop to find a completely new tool or stop to change the driver attachment for a multiple attachment tool. Existing solutions require users to own multiple tools and/or attachments and to take time to switch between tools an attachment each time a new driver head configuration is encountered. This current process is expensive in both time and money as it creates delays for the user to change tools requires multiple tools and attachments be purchased.

The present invention incorporates a plurality, two or more, drive head types into a single tool such that the driver heads of the tool self-adjust to the fastener drive head configuration without requiring the user to buy multiple tools or to stop and waste time changing tools and attachments.

This application describes one embodiment of the invention where a single tool is configured to provide a single device that can be used seamless for slotted head or Philips head driver head configurations.

The tool described herein can be realized in numerous configurations for various combinations of diver head configurations including: but not limited to, combination of Slotted, Philips, Star, Allen, Torx, Pin Security, etc.

The mechanical design of this tool allows for the driver head configuration needed to self-configure as the tool mates with the fastener head to be secured or removed. The mechanical configuration is dynamic providing flexible configuration types while maintaining a strong tool for durable use.

### BRIEF DESCRIPTION OF THE DRAWINGS

FIG. 1 Shows a side view of the fastener driver head configuration for Slotted and Philips Head configurations

FIG. 2 shows a cross sectional view or the fastener driver and the component parts allowing self-configurable fastener heads

FIG. 3 Shows a detailed view of the invention in the described embodiment self-adjusted to a Philips configuration

FIG. 4 shows a detailed view of the invention in the described embodiment self-adjusted to the Slotted configuration

FIG. 5 Shows a cross section view of the invention including the adjustment channel securing the Slotted drove

FIGS. 6 and 7 Show the fastener head engaging with the fastener drive as the drive head self-configures to properly mate to the fastener head configuration to produce proper drive for the attachment or removal of the fastener.

FIGS. 8, 9 and 10 show profile views of the invention as realized in another configuration as a cuck bit for use in a drill or swap release driver handle

FIG. 11 provides a perspective view for FIGS. 8,9, and 10

### DETAILED DESCRIPTION OF THE INVENTION

The invention provides a single tool that incorporates a plurality of fastener driver head configuration such that the configurations of the fastener heads self-configure as they engage with those fastener head configurations incorporated into the tool. Herein used are configurations for the Slotted and Philips Head fastener driver configuration.

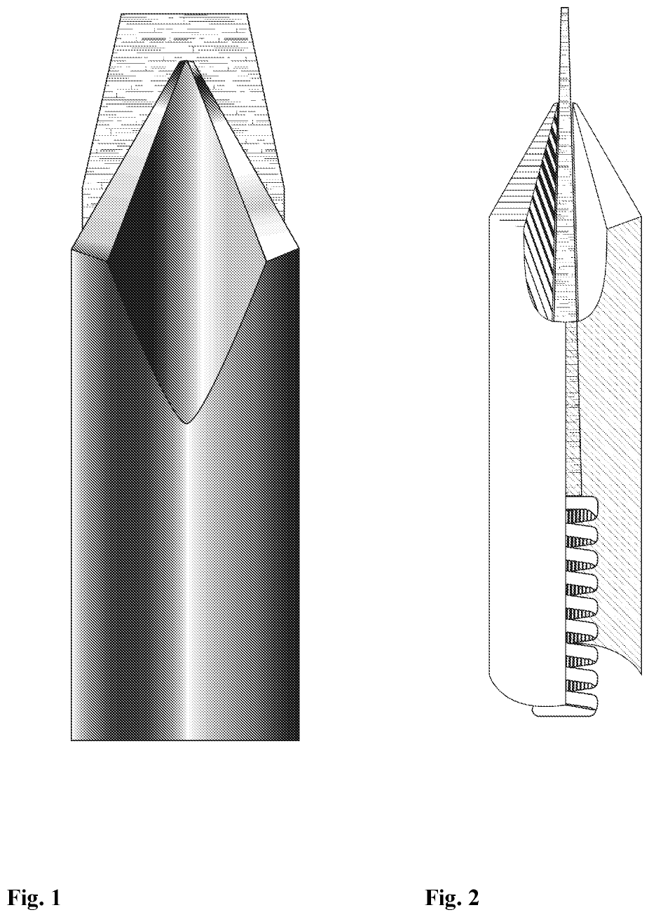

As viewed in FIG. 1 the plurality of drivers (10) (20) is designed as an integral part of the tool wherein the Philips (10) and Slotted (20) Driver are part of a single tool. FIG. 2 shows the side view of the tool with a cross sectional view demonstrating the Philips Slotted head tool traveling within the tool (30) and being held to engagement or allowed to retract for use of the Philips driver by a tension device, spring (40), positioned at the bottom of the blade.

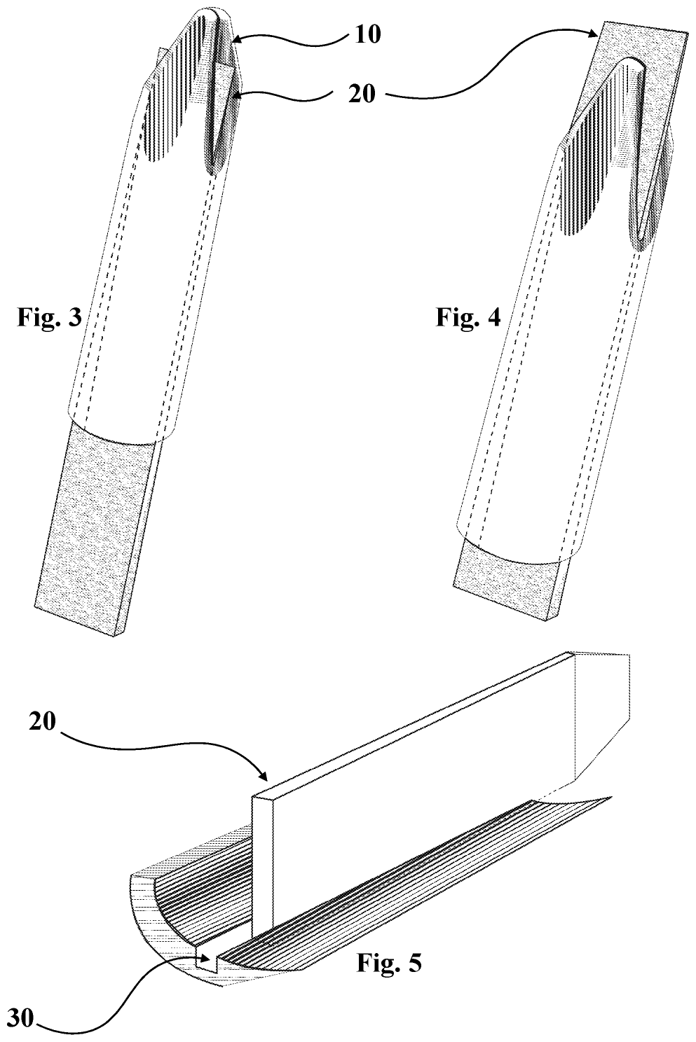

As demonstrated in FIG. 3 the Slotted (20) blade is able to retract and deploy as a part of the engagement of the tool with that type of fastener (50) (60) head configuration without any additional setup or intervention by the user.

FIG. 3 demonstrates the embodiment for Philips configuration, while

FIG. 4 demonstrates that configuration of use in Slotted Head Fasteners.

The Slotted blade travels in a channel (30) incorporated into the interior of the tool such that the blade (20) travels in the channel (30) to ensure both blade stability and strength during use.

The tension device (40) position the moveable element of the drive head configuration, the slotted head (20) so that the device retracts and deploys automatically.

The retractable slotted blades (20) is of a length sufficient to provide a stable and durable tool and the tension element (40) provides a positive negative compression and can be made of various malleable materials or spring configurations.

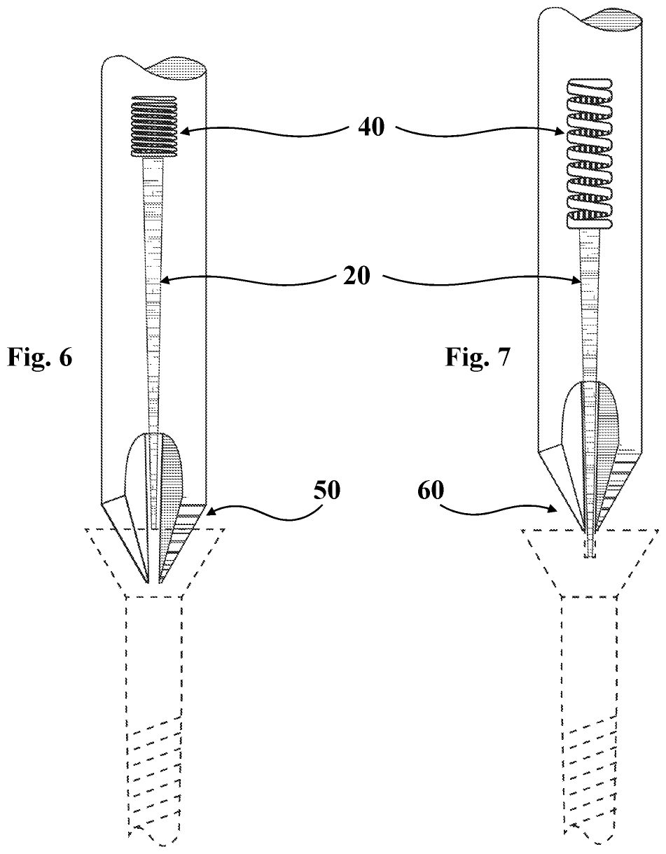

The tools of FIGS. 6 and 7 self-adjust to conform to that fastener configuration type (50) and (60).

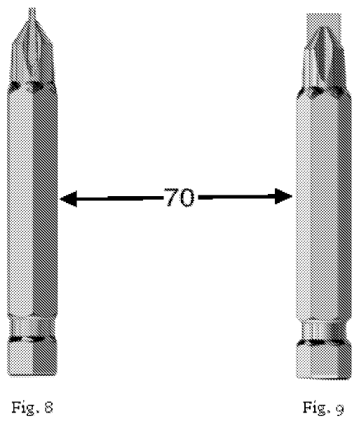

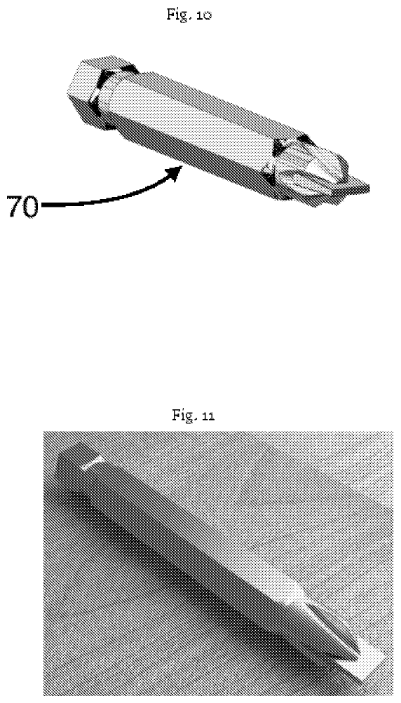

The tool of FIGS. 8, 9 and 10 as realized in a bit cuck configuration for use in a removable holding handle, power or hand drill or other holder devices.

The tool can be realized in various high strength materials providing sufficient rigidity and durability to be useful for the commercial and consumer markets.

The embodiment described herein can be realized in various configuration with various and more numerous driver head types. The self-adjusting mechanism has application and use across various fastener head configuration.

What is claimed:

1. A self-adjusting single fastening tool comprising a hollowed shaft ending with a tip fit for Philips-head fasteners, wherein the tip there is a slot vertically perpendicular to the shaft allowing for a moving flat-headed piece lying within the shaft to partially emerge and retract in and out of said tip via a spring action to a position that would allow said flat-headed piece to drive slotted-head fasteners.
